(19) United States
(12) Patent Application Publication
(10) Pub. No.: US 2009/0308263 A1
(43) Pub. Date: Dec. 17, 2009

(54) DEVICE FOR THE REFRIGERATING AND/OR THE FREEZING OF SUBSTANCES

(76) Inventor: Rudolf Erwin Berghoff, Unterschleissheim (DE)

Correspondence Address: The BOC Group, Inc., 575 MOUNTAIN AVENUE, MURRAY HILL, NJ, 07974-2082, US

(21) Appl. No.: 12/441,423

(22) PCT Filed: Sep. 14, 2007
(86) PCT No.: PCT/EP2007/008001

§ 371 Date: Jul. 29, 2009

(30) Foreign Application Priority Data
Sep. 22, 2006 (DE) 10 2006 045 266.6

(51) Int. Cl. A23B 4/03; F25D 25/04; F25D 17/02

(52) U.S. Cl. 99/476; 62/380; 62/374

(57) ABSTRACT

The invention relates to a device for the refrigerating and/or the freezing of starting substances, in particular of food, comprising two treatment zones, which are enclosed by a housing and which abut directly on one another, wherein heat can be extracted from the starting substances in at least one of the treatment zones in direct or indirect contact with cryogenic liquefied gas, while the second treatment zone encompasses a conveyor belt for conveying the starting substances through the second treatment zone. The device comprises a gas suction device, by means of which a drop of pressure can be generated within the housing and due to which the cold gas, which is generated in the first treatment zone by means of evaporation of cryogenic liquefied gas, discharges from the first treatment zone and subsequently flows through the second treatment zone and also contributes there to the cooling of the product.

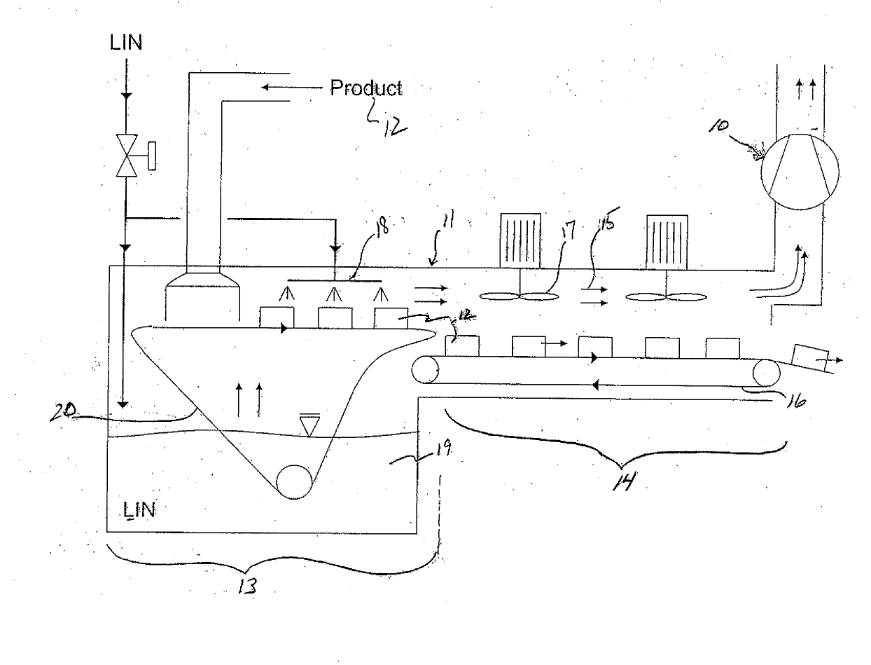

The invention relates to a device for the refrigerating and/or the freezing of starting substances, in particular of food, wherein heat can be extracted from the starting substances with cryogenic liquefied gas.

Refrigerating and/or freezing of food by means of cryogenic liquefied gases takes place in linear freezers, among others. In the classical linear freezer, the liquefied gas is sprayed onto the food, which is to be cooled or frozen, by means of nozzles or by means of spray pipes. The liquefied gas evaporates hereby and is further guided through the linear freezer as cold gas by means of fans, wherein it extracts heat from the food in a convective manner and thus heats up. The heated gas is subsequently fed to a gas suction and is guided into the environment.

For special applications, the refrigerating and freezing, respectively, of the food does not take place by means of spraying but by means of immersion directly into the cryogenic liquefied gas. The devices for carrying out such application, which will be referred to hereinbelow as process freezers, include immersion baths, oscillating troughs, absorbent conveyor belts or steel plate conveyors, for example, in or on which the cold treatment of the food takes place. The cold gas, which is generated in response to such an application by means of evaporation of liquefied gas, either reaches directly into the suction as exhaust gas or it is guided into a subsequent freezer through lead-over pipes, where it is used for the refrigerating. However, it is also state of the art to extract cold gas generated in the process freezer from the process freezer by means of a conveying fan and to convey it into a second freezer, which follows directly. The combination of an immersion bath (process freezer) and a rotary freezer, for example, offered by CES is such a device, where the cold gas generated in the immersion bath is conveyed from the immersion bath into the rotary freezer, which follows directly, by means of a conveying fan.

However, the afore-described devices encompass several serious disadvantages. The conveying fans and the lead-over pipes, for example, which tend to freeze and soil, are hard to clean and thus pose a problem from a hygienic point of view. Lead-over pipes furthermore cause a pressure loss, which must be compensated by means of a higher fan power and they furthermore lead to cold losses.

It is thus the object of the invention to specify a device of the afore-mentioned type, by means of which it is possible to overcome the disadvantages of the state of the art.

Referring to the drawing, the object is solved according to the invention in that it comprises a gas suction device 10, by means of which a drop of pressure can be generated within the housing 11 and due to which the cold gas 15, which is generated in the first treatment zone 13 by means of evaporation of cryogenic liquefied gas, discharges from the first treatment zone 13 and subsequently flows through the second treatment zone 14 and also contributes there to the cooling of the product 12.

The gas 15 flowing towards the gas suction device 10 is a warm gas, which does not lead to a freezing of the gas suction device. Advantageously, the gas suction device 10 is arranged outside of the housing 11, which surrounds the treatment zones 13,14, whereby said gas suction device becomes easily accessible and dirt can be removed therefrom with little effort.

Further embodiments of the device 10 according to the invention provide that
The starting substances 12, which are to be refrigerated and/or frozen, can be transported through the second treatment zone 14 in a counter flow to the cold gas, which discharges from the first treatment zone 13.
The starting substances 12, which are to be refrigerated and/or frozen, can be transported through the second treatment zone 14 in a parallel flow to the cold gas, which discharges from the first treatment zone 13.
The starting substances 12 can be completely or partially transported through the first treatment zone 13 by means of the conveyor belt 16 for conveying the starting substances through the second treatment zone 14.
The second treatment zone 14 encompasses fans 17 for supporting the gas flow within the second treatment zone.
The first treatment zone 13 encompasses at least one device 18 for spraying cryogenic liquefied gas onto the surfaces of starting substances 12.
The first treatment zone 13 encompasses an immersion bath 19, in which heat can be extracted from the starting substances 12 by immersing them into cryogenic liquefied gas.
The first treatment zone 13 encompasses a steel plate conveyor 20 or disk conveyor, which immerses into a cryogenic liquefied gas. The starting substances 12 can be transported through the first treatment zone 13 while lying on said steel plate conveyor or disk conveyor.
The first treatment zone 13 encompasses an absorbent conveyor belt 20, which can be saturated with cryogenic liquefied gas. The starting substances 12 can be transported through the first treatment zone while lying on said conveyor belt.
The first treatment zone 13 encompasses a device for generating a stream of cryogenic liquefied gas, into which the starting substances can be brought and by means of which the starting substances can be transported through the first treatment zone 13.

The device 10 according to the invention makes it possible to carry out the refrigerating and/or freezing of starting substances, in particular of food, as compared to the state of the art, in a more efficient manner, because the cold, which contains cryogenic liquefied gas and which is used as a coolant, can be utilized to an improved extent and the effort for necessary cleaning operations is reduced considerably.

1. A device for the refrigeration and/or the freezing of starting substances, in particular of food, comprising a housing; first and second treatment zones enclosed by the housing and which abut directly on one another, wherein heat can be extracted from the starting substances in at least one of the treatment zones in direct or indirect contact with cryogenic liquefied gas; a conveyor belt encompassed by the second treatment zone for conveying the starting substances through the second treatment zone; and a gas suction device arranged outside of and in fluid communication with the housing to provide a drop of pressure to be generated within the housing such that a cold gas generated in the first treatment zone by means of evaporation of the cryogenic liquefied gas discharges from the first treatment zone and subsequently flows through the second treatment zone wherein the first treatment zone further comprises an immersion bath having the cryogenic liquefied gas therein in which heat can be extracted from the starting substances by immersion into the cryogenic liquefied gas, and the starting substances can be transported through the second treatment zone in a counter flow or in a parallel flow to the cold gas discharged from the first treatment zone.

2. The device according to claim 1, wherein the starting substances can be completely or partially transported through the first treatment zone by the conveyor belt.

3. The device according to claim 1, wherein the second treatment zone comprises fans for supporting the gas flow within the second treatment zone.

4. The device according to claim 1, wherein the second treatment zone comprises at least one spray device for spraying cryogenic liquefied gas onto a surface of the starting substances.

5. The device according to claim 1, wherein the first treatment zone comprises a steel plate conveyor or disk conveyor which immerses into the cryogenic liquefied gas with the starting substances transported through the first treatment zone while lying on said steel plate conveyor or disk conveyor.

6. The device according to claim 1, wherein the first treatment zone comprises an absorbent conveyor belt which can be saturated with cryogenic liquefied gas with the starting substances transported through the first treatment zone while lying on said absorbent conveyor belt.

7. The device according to claim 1, wherein the first treatment zone a comprises another device for generating a stream of cryogenic liquefied gas into which the starting substances can be brought, and means of which the starting substances can be transported through the first treatment zone.
